(19) United States
(12) Patent Application Publication
(10) Pub. No.: US 2002/0139453 A1
(43) Pub. Date: Oct. 3, 2002

(54) Laser transformation hardening and coating of disc brake rotor braking surface

(76) Inventors: Mohan Krishnan, Ann Arbor, MI (US); Kenneth Mark Pickett, Monroe, MI (US)

Correspondence Address: BRINKS HOFER GILSON & LIONE, P.O. BOX 10395, CHICAGO, IL, 60610, US

(21) Appl. No.: 09/818,387

(22) Filed: Mar. 27, 2001

(51) Int. Cl. F16D 65/00

(52) U.S. Cl. 148/565; 188/73.1

(57) ABSTRACT

A method for treating a surface of a brake rotor to enhance the brake rotor's durability is disclosed. The method includes, positioning the brake rotor adjacent a laser light source, wherein the laser light source produces a laser beam, projecting the laser beam onto a surface of the brake rotor, directing a processing gas toward the surface of the rotor adjacent the laser beam, rotating the rotor at a predefined rotational speed, and repeating the above steps until an entire surface of the rotor is treated with the laser beam.

### FIELD OF THE INVENTION

The present invention relates to surface treatment of brake rotors to increase performance, reduce corrosion, and reduce manufacturing costs.

### BACKGROUND ART

Disc braking systems for road vehicles have brake rotors typically made from gray cast iron material. Gray cast iron disc brake rotors are composed of non-uniform segments of graphite, pearlite, and ferrite. Unfortunately, this gray cast iron material is soft and corrodes easily.

A few of the problems that are known to occur are non-uniform wear initiated by machining defects. Non-uniform wear increases noise, vibration, and hardness and reduces breaking uniformity. Generally, the overall wear rate increases with aggressive lining systems requiring premature rotor replacement. Moreover, thermal distortion due to hard breaking produces non-uniform wear and increased noise. Addtionally, increased corrosion caused by vehicles parked for long periods on dealer lots lends to premature rotor replacement.

One prior art method for addressing the problems outlined above is to apply a coating of paint to the brake rotor. While this prior art method eliminates some of the problems stated, other serious problems are still present. Moreover, additional concerns have been raised from the use of paint on brake rotors. More specifically, the application of a layer of paint eventually is worn away resulting in subsequent loss in benefits. Further, other problems have been identified such as the environmental impact and the loss in product performance due to the reduction in the coefficient of friction by the application of the paint on the brake rotor.

Therefore, there exists a need for a method for treating disc brake rotors to overcome the problems stated above. The new method must not adversely effect brake performance and must not adversely impact the environment.

### SUMMARY OF THE INVENTION

In accordance with this and other aspects of the present invention a method for treating a surface of a brake rotor to enhance the brake rotor's durability is provided. The method includes a) positioning the brake rotor adjacent a laser light source, wherein the laser light source produces a laser beam, b) projecting the laser beam onto a surface of the brake rotor c) directing a processing gas toward the surface of the rotor adjacent the laser beam, d) rotating the rotor at a predefined rotational speed, and e) repeating (a) through (d) until an entire surface of the rotor is treated with the laser beam.

In accordance with another aspect of the present invention, nitrogen processing gas is directed toward the surface of the rotor adjacent the laser beam.

In accordance with another aspect of the present invention, the method further includes positioning the brake rotor a predefined standoff height below the laser.

In accordance with another aspect of the present invention, the method further includes positioning the brake rotor a predefined standoff height of 4 mm below the laser.

In accordance with another aspect of the present invention, the method further includes transforming the micro-structure of the brake rotor below the surface of the brake rotor to a depth of about 0.5 to 1.0 mm.

In accordance with another aspect of the present invention, the method further includes projecting the laser beam on another surface of the brake rotor.

In accordance with yet another aspect of the present invention a system for treating a surface of a brake rotor to enhance the brake rotor's durability is provided. The system has a laser light source for producing a laser beam for treating the brake rotor, a fixture for positioning the brake rotor adjacent the laser light source to project the laser beam onto a surface of the brake rotor, and a processing gas directed toward the surface of the rotor adjacent the laser beam. Furthermore, the rotor is rotated at a predefined rotational speed until an entire surface of the rotor is treated with the laser beam.

In accordance with yet another aspect of the present invention, the laser light source is a diode laser.

In accordance with still another aspect of the present invention, a disc brake assembly for inhibiting rotation of a wheel of a motor vehicle is disclosed. The assembly includes, a brake caliper for exerting a clamping force to arrest the wheel, a brake pad in mechanical communication with the brake caliper for transmitting the clamping force, wherein the brake pad has a surface having a high coefficient of friction, and a brake disc rotationally fixed to the wheel and in frictional contact with the wheel when the brake caliper exerts the clamping force on the brake pad. Furthermore, the brake disc has a laser treated brake surface for frictionally contacting the brake pad.

Further objects, features and advantages of the invention will become apparent from consideration of the following description and the appended claims when taken in connection with the accompanying drawings.

### BRIEF DESCRIPTION OF THE DRAWINGS

FIG. 1 is a front view of a disc brake rotor and brake caliper assembly, in accordance with the present invention;

FIG. 2, is a plan view of a disc brake rotor used on a disc brake system, in accordance with the present invention;

FIG. 3 is a schematic diagram illustrating an apparatus for treating the surface of a disc brake rotor with a laser, in accordance with the present invention; and

FIG. 4 is a graph illustrating the performance of disc brake rotors that have been transformed using the method of the present invention.

### DETAILED DESCRIPTION OF THE INVENTION

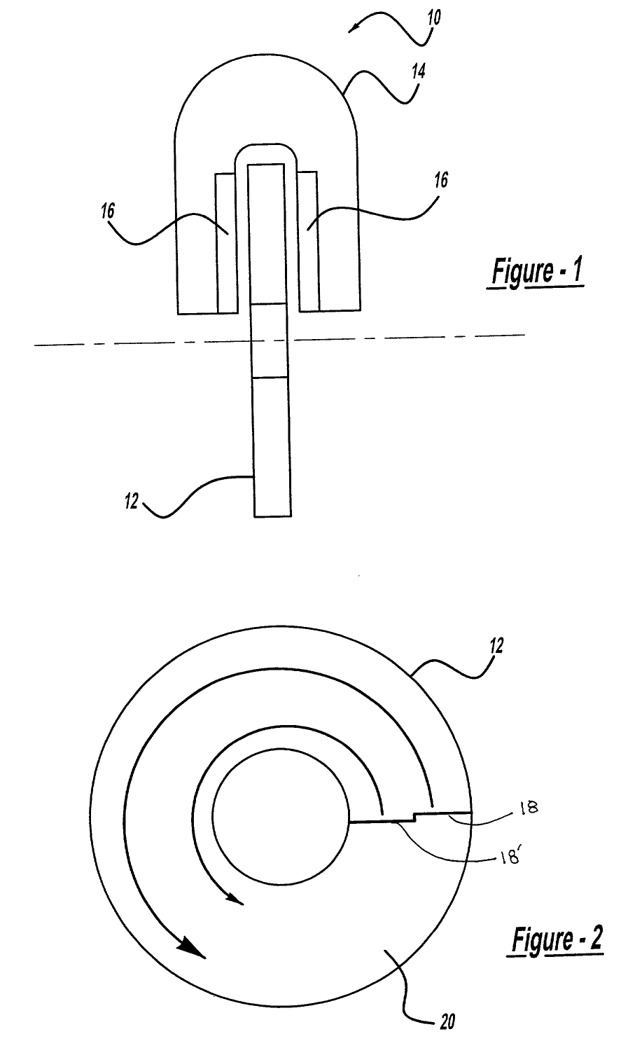

As shown in FIG. 1, a brake caliper and rotor assembly generally indicated by reference number 10 is provided in accordance with the present invention. Assembly 10 is comprised of a brake rotor (brake disc) 12 and a brake caliper 14. Assembly 10 is part of a disc braking system (not shown) for slowing and/or stopping a moving vehicle. The disc braking system, as well know in the art, may provide assembly 10 at each wheel or just at a pair of wheels, such as the front or rear wheels. Caliper 14 further includes a pair of disc brake pads 16 which frictionally engage rotor 12 to limit the movement of the vehicle.

The present invention provides a method for transforming a surface 20 of the brake rotor 12, as illustrated in FIG. 2. In a preferred embodiment, the surface 20 of rotor 12 is hardened using an industrial laser as will be described in further detail hereinafter. Generally, a pair of laser beam spots 18 and 18′ or patterns are projected onto surface 20 to harden the entire surface 20 of rotor 12.

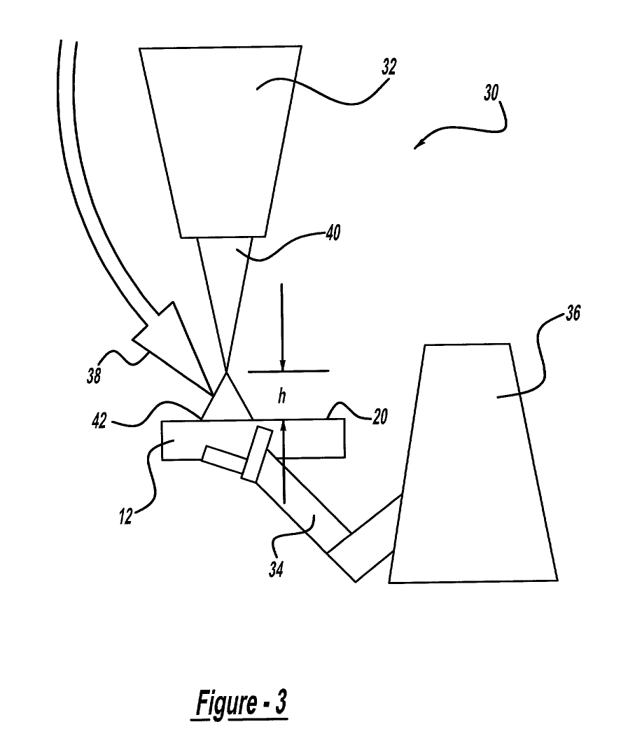

Referring now to FIG. 3, a system for hardening surface 20 of brake rotor 12 is illustrated, in accordance with the present invention. System 30 includes an industrial laser 32, a fixture 34, automation equipment or robot 36 and a process gas delivery nozzle 38. Commercial laser 32 emits a laser beam 40 to produce a laser beam spot 42 on surface 20 of rotor 12. Preferably laser beam 40 is focused above surface 20 of rotor 12 at a predefined standoff height H. The depth at which the rotor is transformed by laser beam 40 is controlled by standoff height H.

Laser processing offers unique transformations of the rotor surface 20. Localized heating offers case hardening with excellent properties. Moreover, distortion is minimized due to heat containment in the laser beam 40. Further, laser processes offer surface coating transformations with unique chemistry and structure (i.e. wear resistance, corrosion resistance, etc.).

The transformation of the brake rotor surface 20 by laser treatment system 30 satisfies the need to create a deep transformation in rotor 12 to address wearing of the brake rotor. It is known that wearing of brake rotors is a bulk phenomena. Laser 36 is a laser capable of transforming the rotor material at depths of 0.5 to 1 mm (millimeter) at high speeds. For example, CO₂, ND:YAG, and diode lasers may be used. Preferably, the diode laser is used since it has been determined that the diode laser is most cost effective for transformation hardening.

In a preferred embodiment of the present invention a method is provided for reducing wear rate by case hardening a machine finished rotor. More specifically, the laser provides superior micro structural properties and lower distortion than other methods which, of course, is vital for rotor performance.

Rotor 12 as described above is treated by laser 32 in a selected gas environment. This gas environment is dispensed by nozzle 38. Preferably, the dispensed gas is nitrogen (N₂) or argon which does not require a vacuum or pressure vessel. In an embodiment of the present invention, it has been determined that the subsurface of the rotor material which undergoes transformation is approximately 300 micrometers thick. Also, the cycle time required to treat each rotor is about 3 to 4 minutes. Of course, transformation thicknesses and processing time may be varied by changing some of the parameters of laser treatment 30, such as the type of laser, standoff height, process gas, etc.

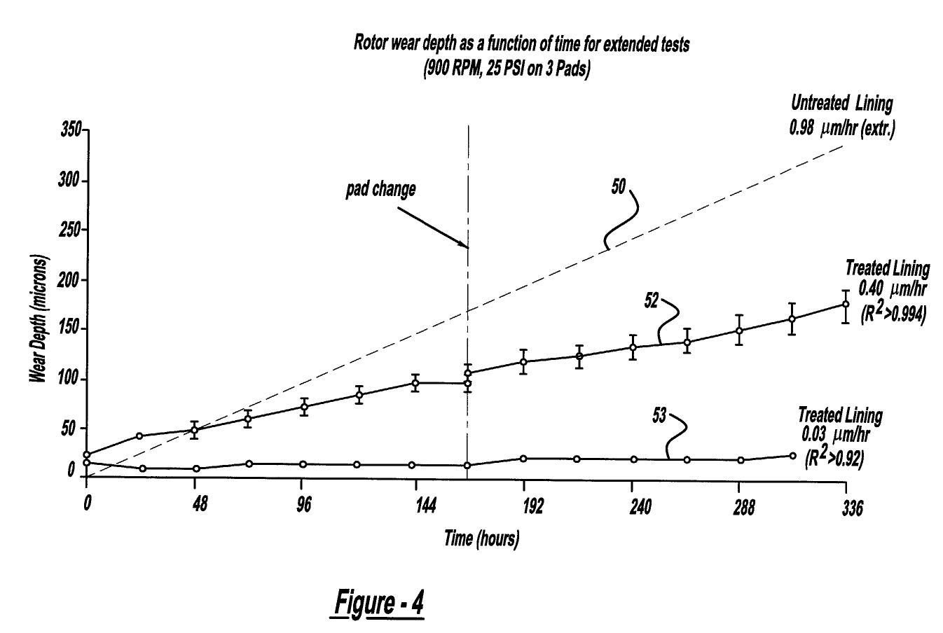

Referring now to FIG. 4, a rotor wear depth as a function of time is illustrated, in accordance with the present invention. Wear depth is indicated on the vertical axis and time is indicated on the horizontal axis. A graph of a rotor not treated with the method of the present invention, is indicated by reference number 50 and a graph of a rotor treated in accordance with the method of the present invention is indicated by reference numeral 52. As would be expected, the wear depth increases linearly over time for both the untreated and treated rotors. However, what is clearly indicated in FIG. 4 is that an untreated rotor as (indicated by line 50) undergoes a higher degree of wear at a given length of time under test. More specifically, the untreated rotor has an increased wear depth as compared with the treated rotor over time.

Thus, the method of the present invention has many advantages and benefits over prior art methods for enhancing the wear resistance of brake rotors. For example, the present invention utilizes a commercial laser to transform the microstructure of a brake rotor without sacrificing brake system performance or adversely impacting the environment. Another significant impact the present invention will have is a dramatic reduction in warranty returns due to uneven wearing of the brake rotors.

The foregoing discussion discloses and describes a preferred embodiment of the invention. One skilled in the art will readily recognize from such discussion, and from the accompanying drawings and claims, that changes and modifications can be made to the invention without departing from the true spirit and fair scope of the invention as defined in the following claims.

What is claimed is:

1. A method for treating a surface of a brake rotor to enhance the brake rotor's durability, the method comprising:
a) positioning the brake rotor adjacent a laser light source, wherein the laser light source produces a laser beam;
b) projecting the laser beam onto a surface of the brake rotor;
c) directing a processing gas toward the surface of the rotor adjacent the laser beam;
d) rotating the rotor at a predefined rotational speed; and
e) repeating (a) through (d) until an entire surface of the rotor is treated with the laser beam.

2. The method of claim 1 wherein directing processing gas further comprises directing nitrogen gas toward the surface of the rotor adjacent the laser beam.

3. The method of claim 1 wherein positioning the brake rotor further comprises positioning the brake rotor a predefined standoff height below the laser.

4. The method of claim 3 wherein positioning the brake rotor further comprises positioning the brake rotor a predefined standoff height of 4 mm.

5. The method of claim 1 further comprising transforming a micro-structure of the brake rotor below the surface of the brake rotor to a depth of about 0.5 to 1.0 mm.

6. The method of claim 1 wherein projecting the laser beam further comprises projecting the laser beam on another surface of the brake rotor.

7. A system for treating a surface of a brake rotor to enhance the brake rotor's durability, the system comprising:
a laser light source for producing a laser beam for treating the brake rotor;
a fixture for positioning the brake rotor adjacent the laser light source to project the laser beam onto a surface of the brake rotor; and
a processing gas directed toward the surface of the rotor adjacent the laser beam, and
wherein the rotor is rotated at a predefined rotational speed until an entire surface of the rotor is treated with the laser beam.

8. The system of claim 7 wherein the processing gas further comprises nitrogen gas.

9. The system of claim 7 wherein the brake rotor is positioned a predefined standoff height below the laser light source.

10. The system of claim 9 wherein the predefined standoff height further comprises a predefined standoff height of 4 mm.

11. The system of claim 7 wherein the laser beam is projected on another surface of the brake rotor.

12. The system of claim 7 wherein the laser light source is a diode laser.

13. A disc brake assembly for inhibiting rotation of a wheel of a motor vehicle, the assembly comprising:
a brake caliper for exerting a clamping force to arrest the wheel;
a brake pad in mechanical communication with the brake caliper for transmitting the clamping force, wherein the brake pad has a surface having a high coefficient of friction; and
a brake disc rotationally fixed to the wheel and in frictional contact with the wheel when the brake caliper exerts the clamping force on the brake pad, wherein the brake disc has a laser treated brake surface for frictionally contacting the brake pad.

14. The assembly of claim 13 wherein the brake disc has another surface wherein the other surface has been laser treated.

15. The assembly of claim 13 wherein the brake disc has a micro-structure below the surface which has been transformed by the laser beam to a depth of between 0.5 millimeters to 1.0 millimeter below the surface.
